(19) United States
(12) Patent Application Publication
(10) Pub. No.: US 2006/0157269 A1
(43) Pub. Date: Jul. 20, 2006

(54) Methods and apparatus for electric bushing fabrication

(76) Inventors: Alvin Benedict Kopp, Dardenne Prairie, MO (US); Jeffrey Daniel Door, St. Louis, MO (US); Peter William Derner, Arnold, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/037,795

(22) Filed: Jan. 18, 2005

(51) Int. Cl. H01B 17/26

(52) U.S. Cl. 174/142

(57) ABSTRACT

Methods and apparatus for a corona free bushing are provided. The bushing includes an insulator including an elongate body having a bore therethrough, and a conductor positioned at least partially within the bore, the conductor including a load current carrying conductive core at least partially clad with at least one layer of a semiconducting insulation, the semiconducting insulation facilitates grading a potential between a radial inner surface of the layer and a radially outer surface of the layer such that corona generated by the conductor is substantially zero.

### BACKGROUND OF THE INVENTION

This invention relates generally to electrical penetrations, and more particularly to corona-free bushings for medium to high voltage electrical equipment.

Bushings are generally used for passing an electrical conductor through a vessel wall of, for example, a transformer or circuit breaker. The conductor is electrically isolated from the vessel wall by a non-conductive sleeve, such as a porcelain insulator. Concentration of charge along the conductor or at specific points on the conductor may cause a breakdown of the dielectric material between the conductor and other bushing components that are operating at a lesser potential. A partial breakdown of the dielectric material may cause partial discharge or corona at the point of concentration of charge. At least some known bushings use alternating foil/paper insulation in a mineral oil-filled porcelain to create a potential gradient between the conductor and the insulator that facilitates reducing corona. Other known bushings use a fluid dielectric medium, such as mineral oil or SF₆, to facilitate reducing corona, and still other known bushings use a combination of a potential gradient and fluid dielectric medium to facilitate reducing corona. However, bushing utilizing these methods are costly, in terms of materials and labor, to fabricate and maintain.

### BRIEF DESCRIPTION OF THE INVENTION

In one aspect, a corona free bushing is provided. The bushing includes an insulator including an elongate body having a bore therethrough, and a conductor positioned at least partially within the bore. The conductor includes a load current carrying conductive core at least partially clad with at least one layer of a semiconducting insulation, and the semiconducting insulation facilitates grading a potential between a radial inner surface of the layer and a radially outer surface of the layer such that corona generated by the conductor is substantially zero.

In another aspect, a method of fabricating a corona free electrical bushing is provided. The method includes providing an insulator that includes a body having a central bore therethrough, and inserting a corona free conductor at least partially into the central bore, the conductor includes at least one insulation layer including a semiconducting material, the semiconductor material facilitating grading a potential between a radial inner surface of the layer and a radially outer surface of the layer such that corona generated by the conductor is substantially zero.

In yet another aspect, an electrical device is provided. The electrical device includes at least one of a vessel and a compartment wall, the wall having an opening therethrough, a corona free bushing inserted at least partially through the opening and fixed in a stationary position with respect to the wall, the bushing including an insulator including an elongate body having a bore therethrough, and a conductor positioned at least partially within the bore, the conductor including a load current carrying conductive core at least partially clad with at least one layer of a semiconducting insulation, the semiconducting insulation facilitates grading a potential between a radial inner surface of the layer and a radially outer surface of the layer such that corona generated by the conductor is substantially zero.

### BRIEF DESCRIPTION OF THE DRAWINGS

FIG. 1 is a cross sectional view of an exemplary electrical bushing assembly; and

FIG. 2 is a cross sectional view of an exemplary portion of a conductor that may be used with bushing assembly shown in FIG. 1.

### DETAILED DESCRIPTION OF THE INVENTION

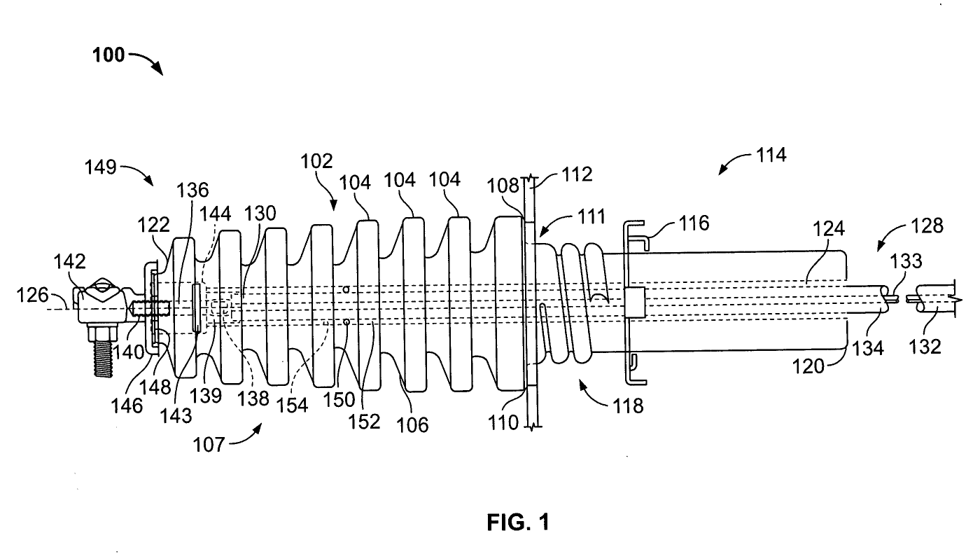

FIG. 1 is a cross sectional view of an exemplary electrical bushing assembly 100. In the exemplary embodiment, bushing 100 is configured for mounting engagement with a transformer housing portion (not shown). Bushing assembly 100 includes an insulating member 102 that may be fabricated from porcelain, ceramic, polymeric resin, or other insulating material capable of performing the functions described herein. Insulating member 102 includes a plurality of integral annular fins or skirts 104 formed on at least a portion of a surface 106 of an exterior portion 107 of insulating member 102 to increase its insulating capacity. Insulating member includes an abutment or flange 108 configured to abut an annular seal or gasket 110 formed of rubber or synthetic elastomer material, such as Buna N. Gasket 110 may be engaged about an opening 111 in a transformer tank 112, or vessel portion, such as a housing cover or lid. A lower or interior portion 114 of insulating member 102 may extend through opening 111 interiorly of transformer tank 112. In the exemplary embodiment, a threaded clamping nut 116 is configured to engage a complementary threaded portion 118 of interior portion 114 to retain insulating member 102 in a substantially fixed position with respect to transformer tank 112.

Insulating member 102 also includes an interior end portion 120, an exterior end portion 122, and a central opening or bore 124 that extends through insulating member 102 along a longitudinal axis 126 between interior end portion 120 and exterior end portion 122. A conductor 128 passes at least partially through bore 124 to facilitate transmitting electrical current between a first end 130 and a second end 132 of conductor 128. In the exemplary embodiment, conductor 128 includes a conductive core 133 and at least one layer of an insulation 134 that may extend at least partially between first end 130 and second end 132. A fastener 136 may engage conductive core 133 along a distal end portion 138, where insulation layer 134 is stripped away, using a crimpable receptacle that is configured to receive distal end portion 138 and then be deformed into a gripping engagement with distal end portion 138. Fastener 136 may also be configured to electrically couple to distal end portion 138 through other fastening means. Fastener 136 and distal end portion 138 may be covered with a second semiconducting insulation 139, which may be, for example, a lapped covering or shrink tube composition. In the exemplary embodiment, fastener 136 includes an opposite threaded portion 140 configured to threadily engage a lead connector 142, which may be configured to engage various electrical cable connector types (not shown). A flange 143 that extends radially outward from fastener 136 may engage an annular shoulder 144 of bore 128 to limit a range of travel of fastener along bore 128 from exterior end portion 122.

An end cap 146 may be used with various seals 148 to seal exterior end portion 122 from environmental intrusion into bore 124 and may also seal exterior end portion 122 from leaking a dielectric fluid (not shown), such as mineral oil, or SF₆ gas from bore 124 to ambient 149. Similarly, an end cap and seal arrangement (not shown) may be incorporated into interior end portion 120 for leakage prevention and/or lateral stabilization of conductor 128 in bore 124.

Bushing assembly 100 may include one or more spacers 150 configured to maintain a gap 152 between conductor 128 and a surface 154 of bore 124. Spacers 150 may surround conductor 128 circumferentially and be spaced axially along conductor 128 such that gap 152 is maintained. Spacers 150 may also be configured to extend axially along conductor 128 and be spaced about a circumference of conductor 128. In an alternative embodiment, an outside diameter of conductor 128 is substantially equal to an inner diameter of bore 124 such that conductor 128 fills at least a portion of bore 124.

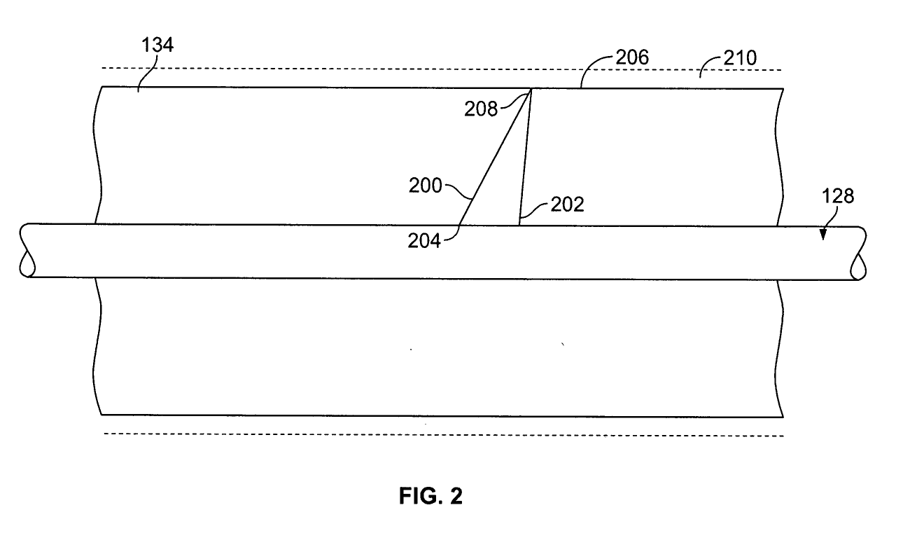

FIG. 2 is a cross sectional view of an exemplary portion of conductor 128 that may be used with bushing assembly 100 (shown in FIG. 1). In the exemplary embodiment, conductive core 133 is fabricated using multiple individual conductive strands covered with an extruded insulation layer 134 comprising ethylene-propylene-rubber (EPR) in close contact with all exterior surfaces of conductive core 133, and fills the outermost spaces between adjacent strands. In an alternative embodiment, conductive core 133 comprises a single conductor, such as a rod or a wire conductor. In other alternative embodiments, conductive core 133 may comprise aluminum or other metallic conductors. EPR has semiconducting properties such that a relatively constant potential gradient 200 is formed between a portion 202 at a first potential magnitude 204 and a portion 206 at a relatively lower potential magnitude 208. Constant potential gradient 200 permits insulation layer 134 to substantially insulate conductive core 133 while suppressing corona and its onset for a predetermined range of voltages that may be applied to conductor 128. In various embodiments of the present invention, other semiconducting materials may be used in place of EPR and the semiconducting material may be applied to conductive core 133 using molding, casting, or other processes. Insulation layer 134 may be at least partially covered by a second layer 210, which may be, but not limited to an insulating layer, a semiconducting layer, and/or a protective sheath.

While the present invention is described with reference to an electrical bushing, numerous other applications are contemplated. It is contemplated that the present invention may be applied to any electrical penetration, such as penetrations into electrical vaults, cable tunnels, bulkheads, and concrete containment buildings in nuclear power facilities.

The above-described apparatus and methods of corona free electrical penetration through walls is cost-effective and highly reliable for electrical distribution and transmission. More specifically, the apparatus and methods described herein facilitate eliminating corona in conductor feed through applications. As a result, the apparatus and methods described herein facilitate reducing electrical distribution and transmission costs in a cost-effective and reliable manner.

Exemplary embodiments of corona free electrical penetrations and methods are described above in detail. The systems are not limited to the specific embodiments described herein, but rather, components of each system may be utilized independently and separately from other components described herein. Each system component can also be used in combination with other system components.

While the invention has been described in terms of various specific embodiments, those skilled in the art will recognize that the invention can be practiced with modification within the spirit and scope of the claims.

What is claimed is:

1. A corona free bushing comprising:
an insulator comprising an elongate body having a bore therethrough; and
a conductor positioned at least partially within said bore, said conductor comprising a load current carrying conductive core at least partially clad with at least one layer of a semiconducting insulation, said semiconducting insulation facilitates grading a potential between a radial inner surface of said layer and a radially outer surface of said layer such that corona generated by said conductor is substantially zero.

2. A bushing in accordance with claim 1 wherein said insulator comprises an interior portion configured to be inserted through a wall of an electrical device, said conductor extending from said interior portion.

3. A bushing in accordance with claim 1 wherein said insulator comprises an interior portion configured to be inserted through a wall of an electrical device, said interior portion comprising an electrical connector coupled to said conductive core, said electrical connector configured to couple to electrical equipment within the electrical device.

4. A bushing in accordance with claim 1 wherein said insulator comprises an interior portion configured to be inserted through a wall of an electrical device, said interior portion comprising an electrical connector coupled to said conductive core, said electrical connector comprising a seal configured to at least one of substantially prevent a leakage of a fluid from the electrical device into said bore and substantially prevent a leakage of a fluid from said bore into the electrical device.

5. A bushing in accordance with claim 1 wherein said insulator comprises an exterior portion configured to be inserted through a wall of an electrical device.

6. A bushing in accordance with claim 1 wherein said insulator comprises at least one of porcelain, ceramic, and polymeric resin.

7. A bushing in accordance with claim 1 wherein said semiconducting insulation comprises ethylene-propylene-rubber (EPR).

8. A bushing in accordance with claim 1 wherein said semiconducting insulation comprises a radially inner surface in contact with said conductive core and a radially outer surface wherein a potential gradient between said inner and outer surfaces is substantially constant.

9. A bushing in accordance with claim 1 wherein said semiconducting insulation comprises a radially inner surface in contact with said conductive core and a radially outer surface wherein a potential gradient between said inner and outer surfaces is non-linear.

10. A method for fabricating a corona free electrical bushing, said method comprising:
providing an insulator that includes a body having a central bore therethrough; and
inserting a corona free conductor at least partially into the central bore, the conductor includes at least one insulation layer comprising a semiconducting material, said semiconductor material facilitating grading a potential between a radial inner surface of said layer and a radially outer surface of said layer such that corona generated by said conductor is substantially zero.

11. A method in accordance with claim 10 wherein inserting a corona free conductor at least partially into the central bore comprises inserting an ethylene-propylene-rubber (EPR) clad conductor at least partially into the central bore.

12. A method in accordance with claim 10 further comprising:
inserting an interior portion of the insulator through an opening in a wall of an electrical device; and
coupling the insulator to the wall.

13. A method in accordance with claim 10 further comprising:
stripping a portion of the insulation layer from the conductive core to form a stripped portion; and
coupling an electrical connector to the stripped portion.

14. A method in accordance with claim 10 further comprising sealing the central bore from at least one of leaking a fluid from the central bore and leaking a fluid into the central bore.

15. An electrical device comprising:
at least one of a vessel and a compartment wall, said wall having an opening therethrough;
a corona free bushing inserted at least partially through said opening and fixed in a stationary position with respect to said wall, said bushing comprising:
an insulator comprising an elongate body having a bore therethrough; and
a conductor positioned at least partially within said bore, said conductor comprising a load current carrying conductive core at least partially clad with at least one layer of a semiconducting insulation, said semiconducting insulation facilitates grading a potential between a radial inner surface of said layer and a radially outer surface of said layer such that corona generated by said conductor is substantially zero.

16. An electrical device in accordance with claim 15 wherein said insulator comprises an electrical connector coupled to said conductive core, said electrical connector comprising a seal configured to at least one of substantially prevent a leakage of a fluid from the electrical device into said bore and substantially prevent a leakage of a fluid from said bore into the electrical device.

17. An electrical device in accordance with claim 15 wherein said insulator comprises at least one of porcelain, ceramic, and polymeric resin.

18. An electrical device in accordance with claim 15 wherein said semiconducting insulation comprises ethylene-propylene-rubber (EPR).

19. An electrical device in accordance with claim 15 wherein said semiconducting insulation comprises a radially inner surface in contact with said conductive core and a radially outer surface wherein a potential gradient between said inner and outer surfaces is substantially constant.

20. An electrical device in accordance with claim 15 wherein said semiconducting insulation comprises a radially inner surface in contact with said conductive core and a radially outer surface wherein a potential gradient between said inner and outer surfaces is non-linear.
